(19) United States
(12) Patent Application Publication
(10) Pub. No.: US 2013/0234785 A1
(43) Pub. Date: Sep. 12, 2013

(54) Apparatus and Method for Feedforward Controlled Charge Pumps

(71) Applicants: Heping Dai, Plano, TX (US); Hengchun Mao, Plano, TX (US)

(72) Inventors: Heping Dai, Plano, TX (US); Hengchun Mao, Plano, TX (US)

(73) Assignee: FutureWei Technologies, Inc., Plano, TX (US)

(21) Appl. No.: 13/418,140

(22) Filed: Mar. 12, 2012

(51) Int. Cl. H02M 3/06

(52) U.S. Cl. 327/536

(57) ABSTRACT

An embodiment apparatus comprises a switched capacitor network coupled between an input voltage and an output capacitor and a feedforward controller. The switched capacitor network comprises a plurality of flying capacitors and a switching circuit. The feedforward controller comprises a sensor configured to detect the input voltage and a mode selector configured to generate a plurality of gate drive signals for the switched capacitor network. The gate drive signals configure the switched capacitor network to form a charge pump with a non-integer multiplication factor.

### TECHNICAL FIELD

The present invention relates to an apparatus and method for switched capacitor regulator circuits, and more particularly, to an apparatus and method for a feedforward controlled charge pump.

### BACKGROUND

An electronic circuit such as a power management controller today often requires input power in a specific range. However, an input power source such as a rechargeable battery or a dc power supply may provide a supply voltage out of the specific range. When the voltage of the input power source is lower than the specific range, a step-up dc/dc converter may be employed to convert the voltage of the input power source into a regulated voltage within the specific range. On the other hand, when the voltage of the input power source is higher than the specific range, a step-down dc/dc converter may be used to convert the voltage of the input power source into a lower voltage to satisfy the operational voltage to which the electronic circuit is specified.

There may be a variety of dc/dc conversion topologies. In accordance with the topology difference, dc/dc converters can be divided into three categories, namely, switching dc/dc converters, linear regulators and charge pump converters. As integrated circuits become increasingly advanced while shrinking in size at the same time, a compact and high efficiency dc/dc conversion topology is desirable. In comparison with other topologies, charge pumps are less complicated because charge pumps are formed by a plurality of flying capacitors and their corresponding switches. In addition, charge pumps have a small footprint and are capable of generating a high efficient power conversion by switching flying capacitors between different charging and discharging phases. As a result, charge pump converters can provide compact and efficient power for integrated circuits. In particularly, charge pump converters may provide a bias voltage (e.g., 5V) for an integrated circuit operating under a 12V input power source.

In order to further improve the efficiency of a charge pump powered integrated circuit, fractional charge pumps may be employed to generate an output voltage equal to the input voltage multiplied by a non-integer multiplication factor. For example, a 1-to-1.5 charge pump can boost the output voltage to as much as 1.5 times the input voltage. There may be two flying capacitors in a 1-to-1.5 charge pump. The 1-to-1.5 charge pump operates by switching the two flying capacitors between two phases. During the first phase, the two flying capacitors are connected in series and charged from the input voltage source. According to the capacitor divider theorem, the voltage across each flying capacitor is about one half of the input voltage. During the second phase, after a reconfiguration of the flying capacitors, the two flying capacitors are connected in parallel and stacked on top of the input voltage source. As a result, the total voltage to the load is about 1.5 times the input voltage.

As technologies evolve, advanced integrated circuits may require a precisely regulated bias voltage. In order to satisfy the requirements of advanced integrated circuits, the output voltage of a charge pump may be regulated by controlling the amount of charge transferred from the input voltage source. In particular, the turn on time of the switches in a charging phase may be adjusted in response to a feedback signal detected from the output voltage of the charge pump. The turn on time of the switches of the charging phase may be alternatively referred to as a duty cycle of the charge pump or a duty cycle of the charging phase. Likewise, the output voltage can be regulated by adjusting the turn on time of the switches in a discharging phase or the duty cycle of the discharging phase. Furthermore, the output voltage of the charge pump can be regulated by adjusting the switching frequency of the charge pump. More particularly, the charging time of the charge pump may be fixed. In order to regulate the output voltage, the discharging time of the charge pump may vary to offset the voltage variations due to load changes or input voltage fluctuations.

### SUMMARY OF THE INVENTION

These and other problems are generally solved or circumvented, and technical advantages are generally achieved, by preferred embodiments of the present invention which provide an apparatus and method for reducing the output voltage variations and transients of a feedforward controlled charge pump.

In accordance with an embodiment, an apparatus comprises a switched capacitor network coupled between an input voltage and an output capacitor, wherein the switched capacitor network comprises a plurality of flying capacitors and a switching circuit and a feedforward controller comprising a sensor configured to detect the input voltage and a mode selector configured to generate a plurality of gate drive signals for the switched capacitor network based upon the input voltage, wherein the plurality of gate drive signals configure the switched capacitor network to form a first charge pump with a first multiplication factor, and wherein the first multiplication factor keeps an output voltage of the switched capacitor network within a predetermined range.

In accordance with another embodiment, a charge pump comprises a plurality of flying capacitors coupled between an input dc voltage source and an output capacitor, a switching circuit coupled to the plurality of flying capacitors, wherein the switching circuit and the plurality of flying capacitors form a switched capacitor network, wherein the switching circuit has a plurality of configurations, each of which forms a charge pump with a multiplication factor and a feedforward controller configured to detect an input dc source voltage and configure the switching circuit to form a charge pump with a first multiplication factor based upon the input dc source voltage.

In accordance with yet another embodiment, a method comprises detecting an input voltage and configuring a switched capacitor network such that the switched capacitor network forms a charge pump with a lower multiplication factor when the input voltage is more than a threshold.

An advantage of an embodiment of the present invention is reducing the output voltage variations and transients of a fractional charge pump so as to improve the efficiency, reliability and cost of the fractional charge pump.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a feedforward controlled charge pump in accordance with an embodiment;

FIG. 2 illustrates a block diagram of the feedforward controller shown in FIG. 1 in accordance with an embodiment;

FIG. 3 illustrates a schematic diagram of the switched capacitor network shown in FIG. 1 in accordance with an embodiment;

FIG. 4 illustrates a schematic diagram of a ½ charge pump derived from the switched capacitor network shown in FIG. 3;

FIG. 5 illustrates a schematic diagram of a ⅖ charge pump derived from the switched capacitor network shown in FIG. 3;

FIG. 6 illustrates a schematic diagram of a ⅗ charge pump derived from the switched capacitor network shown in FIG. 3;

FIG. 7 illustrates a schematic diagram of a ⅓ charge pump derived from the switched capacitor network shown in FIG. 3;

FIG. 8 illustrates a schematic diagram of a ⅔ charge pump derived from the switched capacitor network shown in FIG. 3;

FIG. 9 illustrates a schematic diagram of a ¼ charge pump derived from the switched capacitor network shown in FIG. 3;

FIG. 10 illustrates a schematic diagram of a ¾ charge pump derived from the switched capacitor network shown in FIG. 3;

FIG. 11 illustrates a schematic diagram of a 1-to-1 charge pump derived from the switched capacitor network shown in FIG. 3;

FIG. 12 shows two curves illustrating the output voltage versus the input voltage in accordance with an embodiment;

FIG. 13 illustrates in detail the duty modulation control mechanism shown in FIG. 12;

FIG. 14 shows two curves illustrating the output voltage versus the input voltage in accordance with another embodiment; and

FIG. 15 shows two curves illustrating the output voltage versus the input voltage in accordance with yet another embodiment.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a feedforward controlled charge pump in a power management integrated circuit. The invention may also be applied, however, to a variety of integrated circuits such as bias voltage sources or low power dc/dc converters.

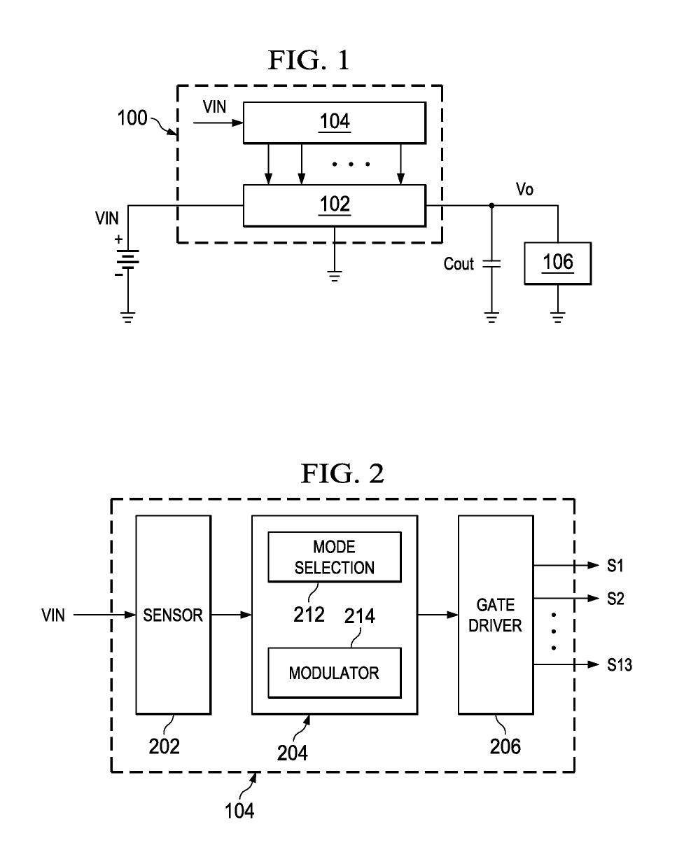

Referring initially to FIG. 1, a block diagram of a feedforward controlled charge pump is illustrated in accordance with an embodiment. The feedforward controlled charge pump 100 is coupled between an input dc voltage source VIN and a load 106. An output capacitor Cout is employed to smooth the voltage ripple generated by the charging and discharging of the output of the feedforward controlled charge pump 100. The feedforward controlled charge pump 100 may comprise a switched capacitor network 102 and a feedforward controller 104. As shown in FIG. 1, the switched capacitor network 102 has a first terminal coupled to the input dc voltage source VIN, a second terminal coupled to the output Vo and a third terminal coupled to ground. In addition, there may be a plurality of gate drive signals sent from the feedforward controller 104 to the switched capacitor network 102.

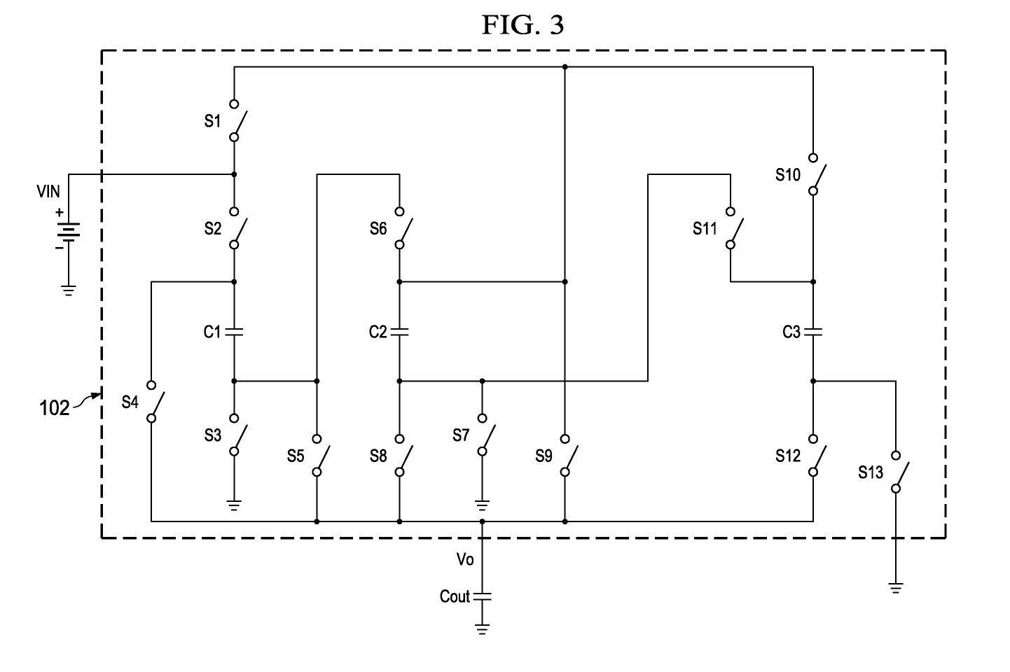

The switched capacitor network 102 may comprise a plurality of flying capacitors (not shown but illustrated in FIG. 3) and switching circuitry (not shown but illustrated in FIG. 3). The switching circuitry may operate in a high switching frequency such as 10 MHz. The switched capacitor network 102 can be configured to form charge pumps with different multiplication factors. Depending on different input voltages, the feedforward controller 104 may generate different gate drive signals to reconfigure the switched capacitor network 102 so as to form a charge pump with a different multiplication factor to offset the output voltage variation due to the input voltage change.

In accordance with an embodiment, when the input voltage source VIN is low (e.g., 10V), the switched capacitor network 102 may be configured to form a charge pump with a first non-integer multiplication factor (e.g., ½ charge pump). On the other hand, when the input voltage source VIN is high (e.g., 15V), the switched network 102 may be reconfigured to form a charge pump with a second non-integer multiplication factor (e.g., ⅓ charge pump). As such, the output voltage of the charge pump 100 may stay almost constant around 5V. By employing the mode change control described above, the output voltage of the charge pump can be fine-tuned in response to the input voltage change.

In sum, the feedforward controlled switched capacitor network 102 helps to reduce the output voltage variation by changing the multiplication factor of the charge pump 100. In addition, the feedforward controlled switched capacitor network 102 helps to reduce a voltage rate of change per unit time (dv/dt) of the output voltage. The detailed operation of the feedforward controlled charge pump 100 will be described below with respect to FIGS. 3-11.

FIG. 2 illustrates a block diagram of the feedforward controller 104 shown in FIG. 1 in accordance with an embodiment. The feedforward controller 104 may comprise a sensor 202, a feedforward control unit 204 and a gate driver 206. The sensor 202 is coupled to the input voltage source VIN. In accordance with an embodiment, the sensor 202 may be implemented by using a resistor divider. Alternatively, the senor 202 may be implemented by using other divider circuits such as a capacitor divider. The sensor 202 is employed to scale down the input voltage source VIN to an appropriate range suitable for the feedforward control unit 204.

The feedforward control unit 204 may further comprise a mode selector 212 and a modulator 214. Based upon the sensed input voltage sent from the sensor 202, the feedforward control unit 204 is capable of adjusting the output voltage so as to keep the output voltage within a specified range. In particular, in response to the input voltage fluctuation, the feedforward control unit 204 may configure the charge pump to operate in a different duty cycle or a different operating frequency through the modulator 214.

Alternatively, the feedforward control unit 204 may configure the charge pump to operate in a different mode through the mode selector 212. In other words, the mode selector 212 may change the capacitor configuration of the switched capacitor network 102 in response to different input voltages. For example, when the input voltage is low (e.g., 10V), a fractional charge pump with a higher non-integer multiplication factor (e.g., ½) may be configured by selecting a particular group of flying capacitors. When the input voltage is high (e.g., 15V), the mode selector 212 may reconfigure the switched capacitor network 102 to form a fractional charge pump with a lower non-integer multiplication factor (e.g., ⅓). As such, the output voltage of the charge pump stays at a constant voltage (e.g., 5V) despite that the input voltage changes from 10V to 15V. It should be noted that the step-down application used in the previous example are selected purely for demonstration purposes and are not intended to limit the various embodiments of the present invention to step-down applications. Instead, other applications such as step-up power conversions are fully intended to be included within the scope of the embodiments discussed herein.

Furthermore, the duty/frequency modulation mechanism from the modulator 214 can be combined with the mode change mechanism from the mode selector 212. For example, when the input voltage VIN is high (e.g., 15V), a fractional charge pump with a lower non-integer multiplication factor (e.g., ⅓) may be configured by selecting a particular group of capacitors. As the input voltage changes from 15V to 10V, the duty cycle or frequency may be adjusted to compensate the input voltage fluctuations so as to maintain the output voltage within the specified range.

When the input voltage VIN reaches a predetermined threshold such as 10V, the mode selector 212 may reconfigure the switched capacitor network 102 to form a charge pump with a higher non-integer multiplication factor (e.g., ½). As such, the output voltage of the charge pump stays at a constant voltage (e.g., 5V) despite that the input voltage changes from 15V to 10V. One advantage of having the feedforward controller 204 is that the output voltage of the charge pump 100 can be fine-tuned so as to remain within a specified range despite variations in the input voltage. In addition, the fine-tuned output voltage represents a lower dv/dt, which helps to reduce EMI noise.

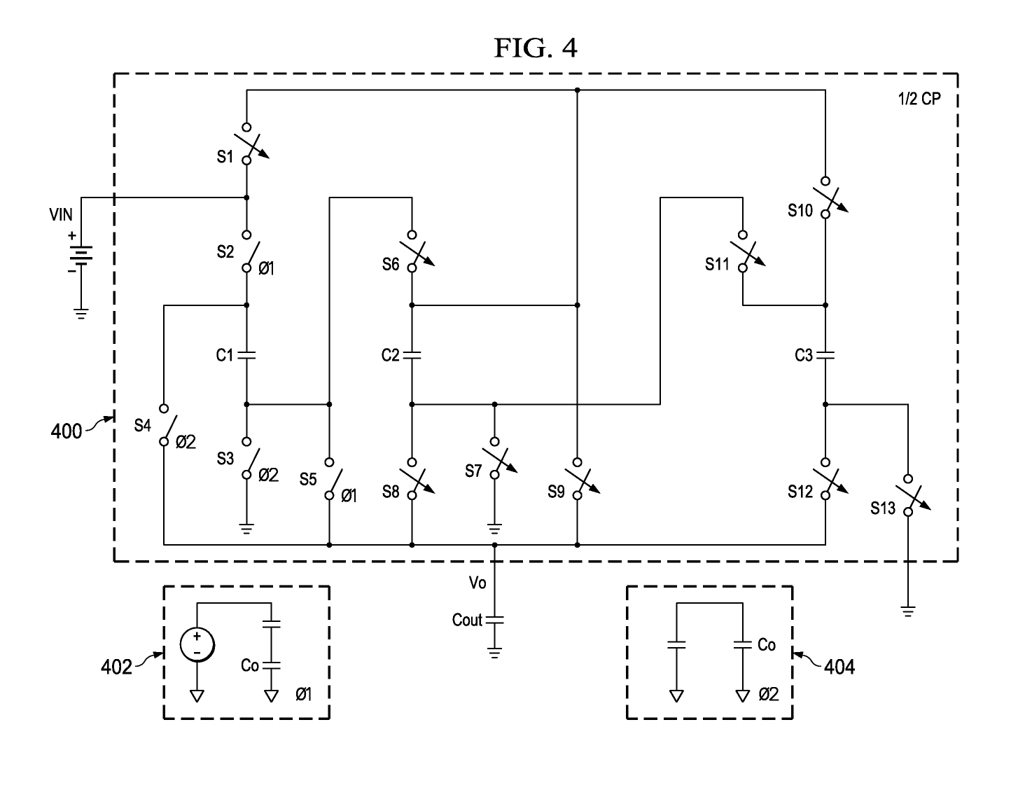

FIG. 3 illustrates a schematic diagram of the switched capacitor network shown in FIG. 1 in accordance with an embodiment. The switched capacitor network 102 may comprise three flying capacitors, namely first flying capacitor C1, second flying capacitor C2 and third flying capacitor C3. In addition, the switching circuitry of the switched capacitor network 102 may comprise thirteen switches (S1 to S13). By activating different switches, different multiplication factors can be obtained. The basic switched capacitor network 102 shown in FIG. 3 can be configured to form charge pumps with multiplication factors from 0.25 to 1. The schematic diagrams of ½, ⅖, ⅗, ⅓, ⅔, ¼, ¾ and 1-to-1 charge pumps are illustrated below with respect to FIGS. 4 to 11.

It should be noted that while FIG. 3 illustrates the switched capacitor network 102 having three flying capacitors and corresponding switching circuitry, a person skilled in the art will recognize that the switched capacitor network 102 may accommodate any number of flying capacitors. It should further be noted that by selecting different number of flying capacitors and their associated switches, the switched capacitor network 102 may form a charge pump with any multiplication factor. The schematic diagram shown in FIG. 3 is merely an example. A person skilled in the art will recognize that the inventive aspects of the present invention are not limited by the number of flying capacitors.

FIG. 4 illustrates a schematic diagram of a ½ charge pump derived from the switched capacitor network shown in FIG. 3. The black bold arrows shown in FIG. 4 indicate that the switches under the black bold arrows are disabled in order to configure the switched capacitor network 102 to form a ½ charge pump. In FIG. 4, because switches S1 and S6-S13 are inactive, the flying capacitors C2 and C3 are excluded from the charging and discharging processes of the ½ charge pump 400. As a result, the flying capacitor C1 and its associated switches S2, S3, S4 and S5 form the ½ charge pump 400.

The ½ charge pump 400 may operate at a switching frequency of 10 MHz. Each switching cycle can be further divided into a charging phase and a discharging phase. During a charging phase, the flying capacitor C1 is stacked on top of the output capacitor Cout by turning on switches S2, S5 and turning off switches S3, S4. During a discharging phase, the flying capacitor C1 is discharged to the output capacitor Cout through a conductive path formed by the turned on S4 and S5. Simplified schematic diagrams 402 and 404 illustrate the equivalent circuits of the ½ charge pump 400 during the charging phase and the discharging phase respectively.

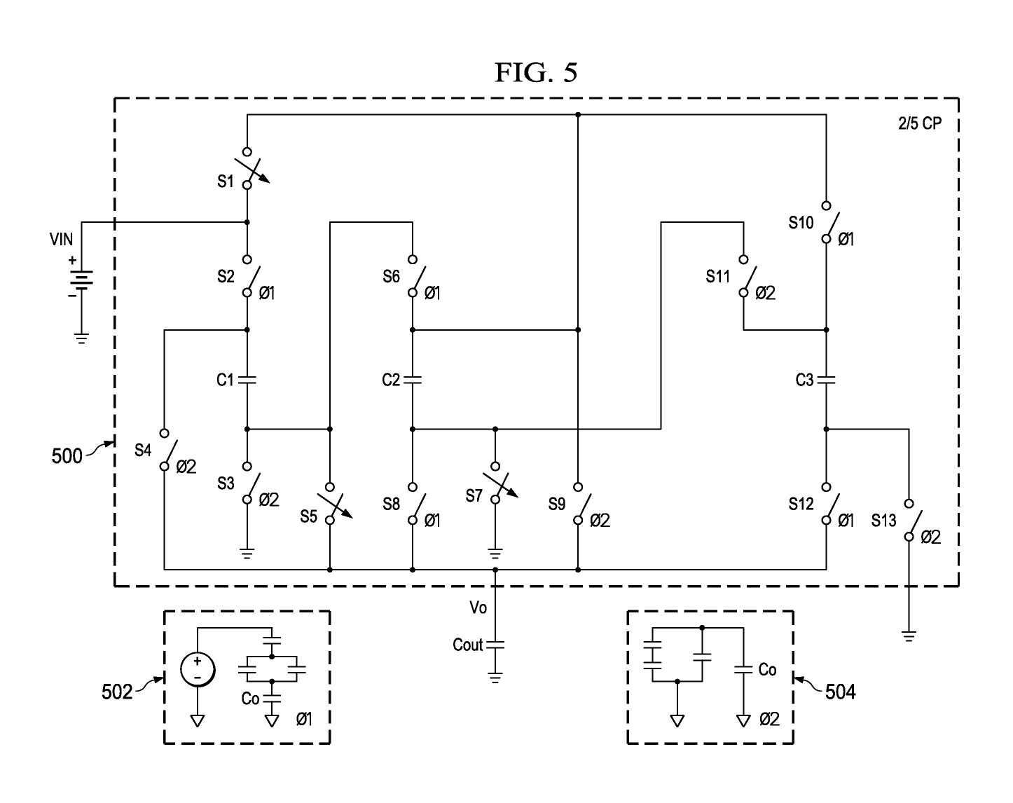

FIG. 5 illustrates a schematic diagram of a ⅖ charge pump derived from the switched capacitor network shown in FIG. 3. As shown in FIG. 5, switches S1, S5 and S7 are disabled. The rest switches of FIG. 5 can be divided into two groups. The first group of switches S2, S6, S8, S10 and S12 are turned on during the charging phase. As a result, flying capacitors C2 and C3 are connected in parallel and further connected in series with the flying capacitor C1. A simplified schematic diagram 502 illustrates the equivalent circuit of the ⅖ charge pump 500 operating in the charging phase.

During a discharging phase, the second group of switches S3, S4, S9, S11 and S13 are turned on and the switches in the first group are turned off. As a result, flying capacitors C2 and C3 are connected in series and further connected in parallel with the flying capacitor C1. A simplified schematic diagram 504 illustrates the equivalent circuit of the ⅖ charge pump 500 operating in the discharging phase. According to the charge pump operation principles, the equivalent circuits 502 and 504 shows the flying capacitors and their associated switches form a ⅖ charge pump.

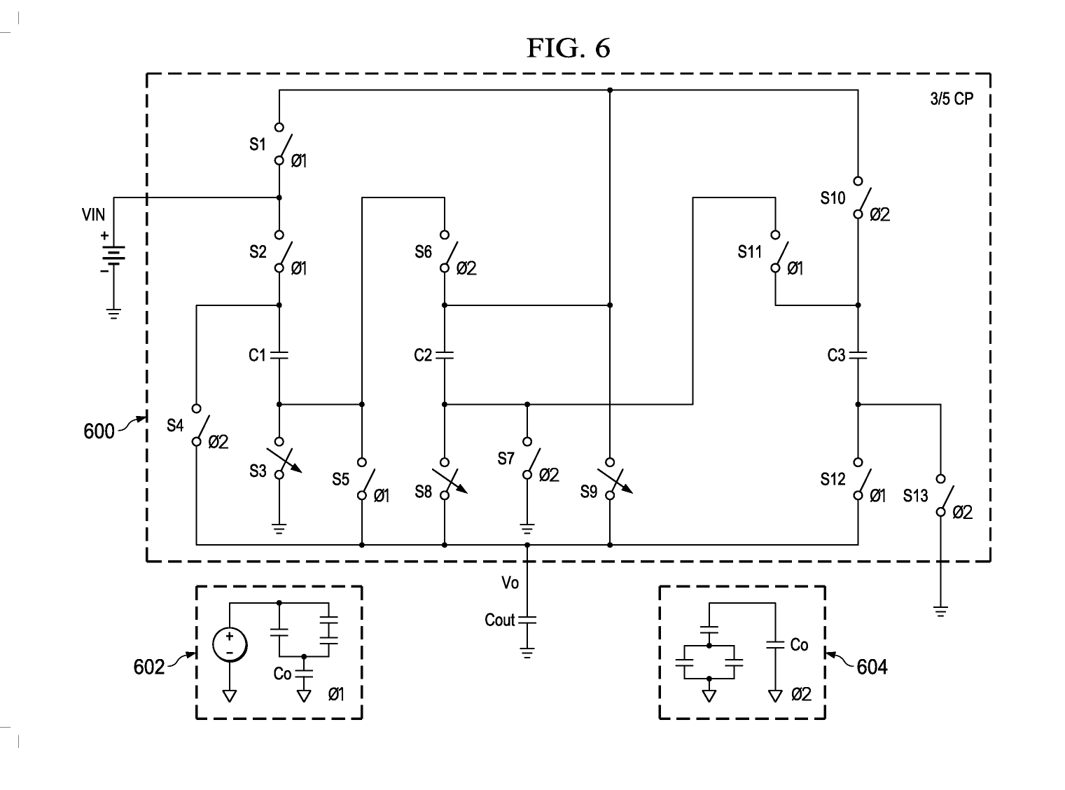

FIG. 6 illustrates a schematic diagram of a ⅗ charge pump derived from the switched capacitor network shown in FIG. 3. As shown in FIG. 6, switches S3, S8 and S9 are disabled. The rest switches of FIG. 5 can be divided into two groups. The first group of switches S2, S5, S1, S11 and S12 are turned on during the charging phase. As a result, flying capacitors C2 and C3 are connected in series and further connected in parallel with the flying capacitor C1.

During a discharging phase, the second group of switches S13, S10, S7, S6 and S4 are turned on and the switches of the first group are turned off. As a result, flying capacitors C2 and C3 are connected in parallel and further connected in series with the flying capacitor C1. Simplified schematic diagrams 602 and 604 illustrate the equivalent circuits of the ⅗ charge pump 600 during the charging phase and the discharging phase respectively. According to the charge pump operation principles, the charging and discharging capacitor configuration shows the flying capacitors and their associated switches form a ⅗ charge pump.

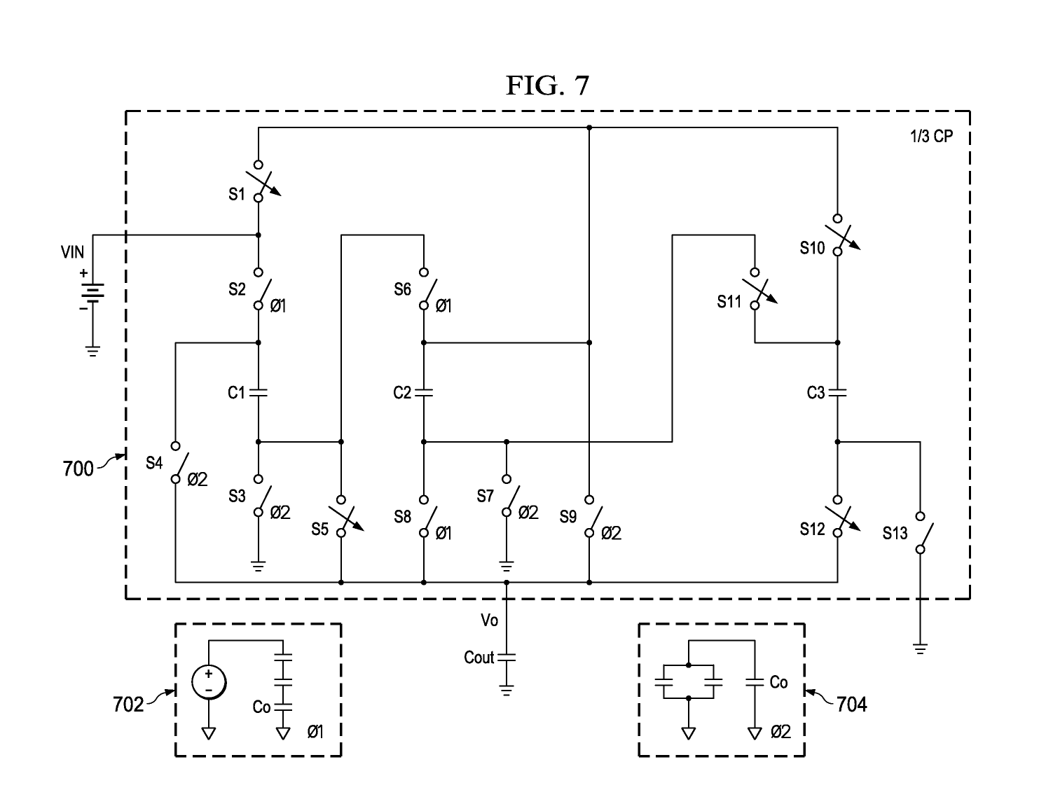

FIG. 7 illustrates a schematic diagram of a ⅓ charge pump derived from the switched capacitor network shown in FIG. 3. As shown in FIG. 7, switches S1, S5, S10, S11, S12 and S13 are disabled. The rest switches of FIG. 7 can be divided into two groups. The first group of switches S2, S6 and S8 are turned on during the charging phase. As a result, flying capacitors C1 and C2 are connected in series and coupled between the input dc source VIN and the output capacitor Cout. A simplified schematic diagram 702 illustrates the equivalent circuit of the ⅓ charge pump 700 operating in the charging phase.

During a discharging phase, the second group of switches S3, S4, S7, and S9 are turned on and the switches of the first group are turned off. As a result, flying capacitors C1 and C2 are connected in parallel and the energy stored in the flying capacitors C1 and C2 are transferred to the output capacitor Cout. A simplified schematic diagram 704 illustrates the equivalent circuit of the ⅓ charge pump 700 operating in the discharging phase. According to the charge pump operation principles, the charging and discharging capacitor configuration shows the flying capacitors and their associated switches form a ⅓ charge pump.

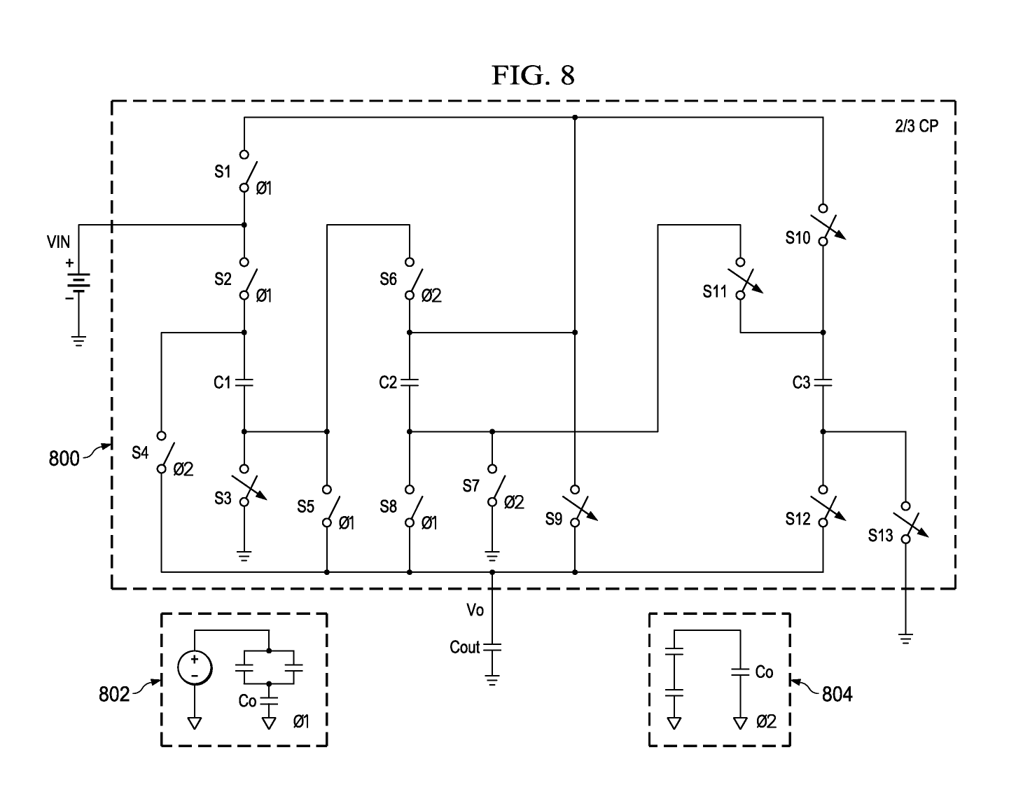

FIG. 8 illustrates a schematic diagram of a ⅔ charge pump derived from the switched capacitor network shown in FIG. 3. As shown in FIG. 8, switches S3, S9, S10, S11, S12 and S13 are disabled. The rest switches of FIG. 8 can be divided into two groups. The first group of switches S1, S2, S5 and S8 are turned on during the charging phase. As a result, flying capacitors C1 and C2 are connected in parallel and coupled between the input dc source VIN and the output capacitor Cout. A simplified schematic diagram 802 illustrates the equivalent circuit of the ⅓ charge pump 800 operating in the charging phase.

During a discharging phase, the second group of switches S4, S6 and S7 are turned on and the switches of the first group are turned off. As a result, flying capacitors C1 and C2 are connected in series and the energy stored in the flying capacitors C1 and C2 are transferred to the output capacitor Cout. A simplified schematic diagram 804 illustrates the equivalent circuit of the ⅓ charge pump 800 operating in the discharging phase. According to the charge pump operation principles, the charging and discharging capacitor configuration shows the flying capacitors and their associated switches form a ⅔ charge pump.

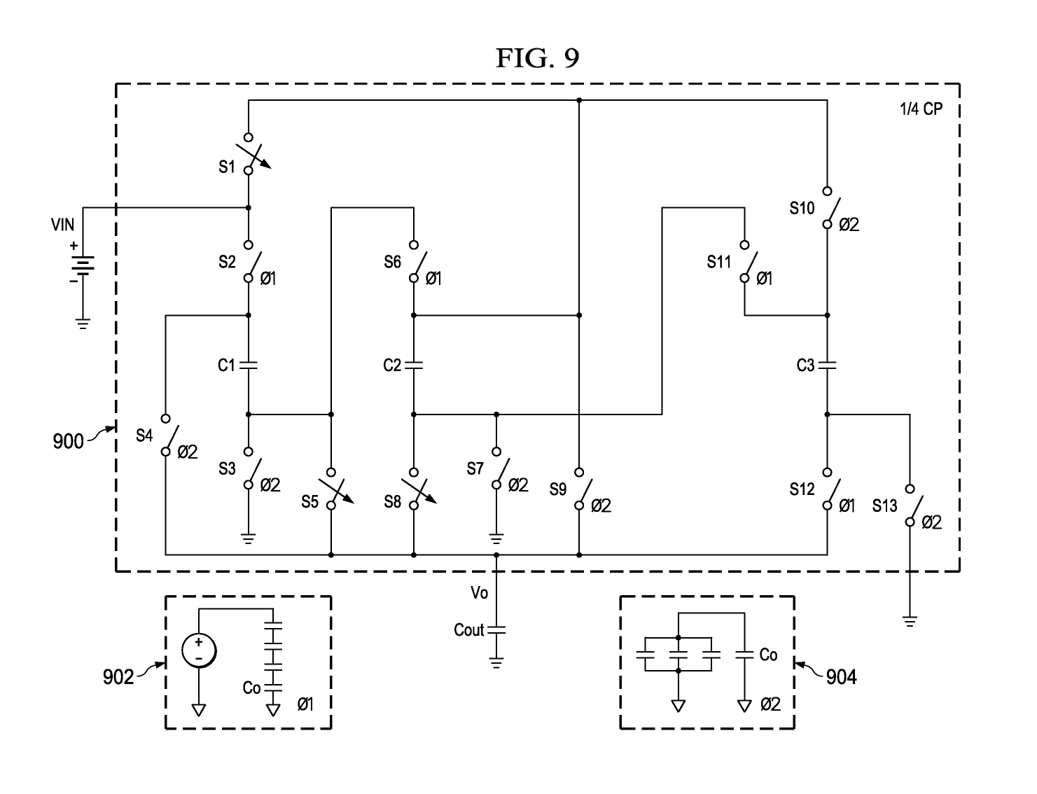

FIG. 9 illustrates a schematic diagram of a ¼ charge pump derived from the switched capacitor network shown in FIG. 3. As shown in FIG. 9, switches S1, S5 and S8 are disabled. The rest switches of FIG. 9 can be divided into two groups. The first group of switches S2, S6, S11 and S12 are turned on during the charging phase. As a result, flying capacitors C1, C2 and C3 are connected in series and coupled between the input dc source VIN and the output capacitor Cout.

During a discharging phase, the second group of switches S3, S4, S7, S9, S10 and S13 are turned on and the switches of the first group are turned off. As a result, flying capacitors C1, C2 and C3 are connected in parallel and the energy stored in the flying capacitors C1, C2 and C3 are transferred to the output capacitor Cout. According to the charge pump operation principles, the charging equivalent circuit 902 and discharging equivalent circuit 904 show the flying capacitors and their associated switches form a ¼ charge pump.

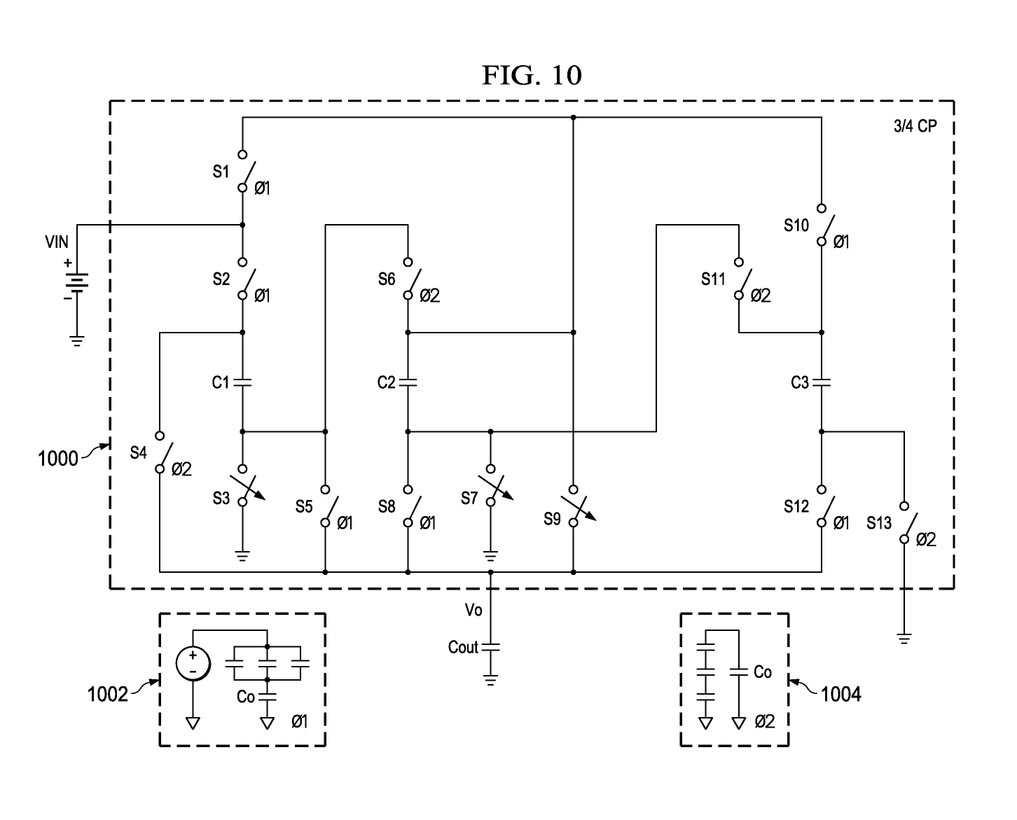

FIG. 10 illustrates a schematic diagram of a ¾ charge pump derived from the switched capacitor network shown in FIG. 3. As shown in FIG. 10, switches S3, S7 and S9 are disabled. The rest switches of FIG. 10 can be divided into two groups. The first group of switches S1, S2, S5, S8, S10 and S12 are turned on during the charging phase. As a result, flying capacitors C1, C2 and C3 are connected in parallel and coupled between the input dc source VIN and the output capacitor Cout.

During a discharging phase, the second group of switches S4, S6, S11 and S13 are turned on and the switches of the first group are turned off. As a result, flying capacitors C1, C2 and C3 are connected in series and the energy stored in the flying capacitors C1, C2 and C3 are transferred to the output capacitor Cout. According to the charge pump operation principles, the charging equivalent circuit 1002 and the discharging equivalent circuit 1004 show the flying capacitors and their associated switches form a ¾ charge pump.

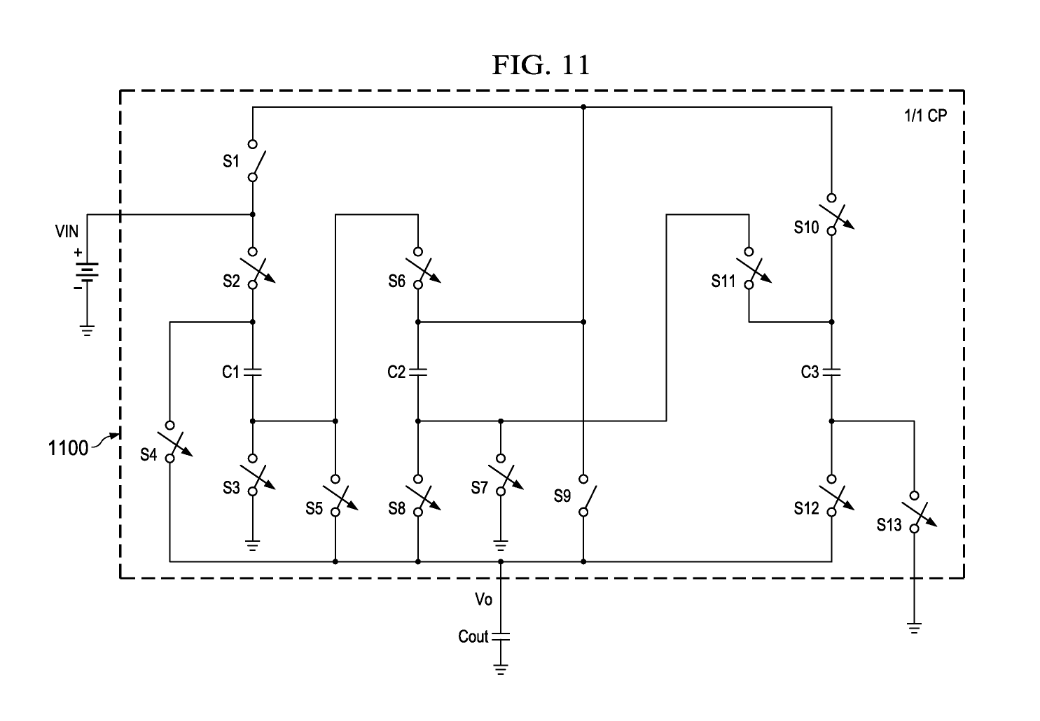

FIG. 11 illustrates a schematic diagram of a 1-to-1 charge pump derived from the switched capacitor network shown in FIG. 3. As shown in FIG. 10, switches S2, S3, S4, S5, S6, S7, S8, S10, S11, S12 and S13 are disabled. By turning on both switch S1 and S9, the input dc voltage VIN is coupled to the output capacitor Cout directly. As such, the output voltage Vo is approximately equal to the input voltage VIN.

In sum, FIGS. 4-11 show the switched capacitor network 102 (shown in FIG. 3) is capable of generating output voltages with different input/output ratios. Furthermore, the switched capacitor network 102 as well as the feedforward controller 104 can compensate the output voltage variation by selecting different multiplication factors. As such, the output voltage of the feedforward controlled charge pump 100 may stay almost constant despite input voltage fluctuations.

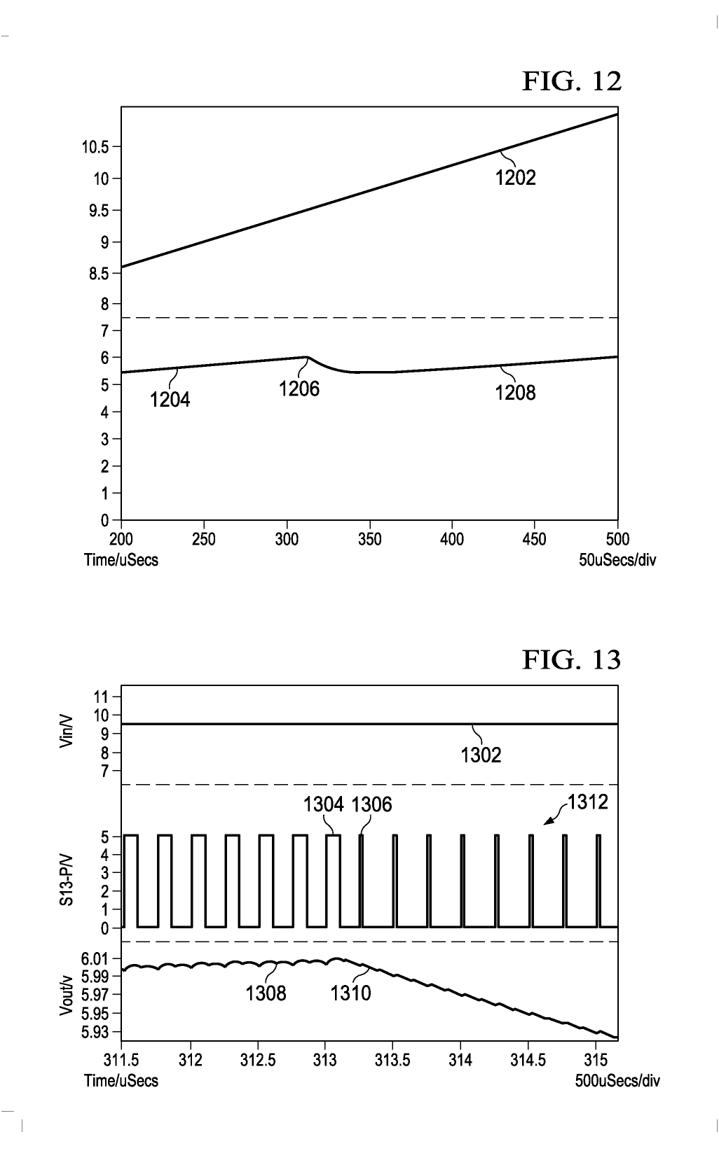

FIG. 12 shows two curves illustrating the output voltage versus the input voltage in accordance with an embodiment. The horizontal axis of FIG. 12 is a time axis. The upper vertical axis of FIG. 12 represents the input voltage of a feedforward controlled charge pump. The bottom vertical axis of FIG. 12 represents the output voltage of the feedforward controlled charge pump. A curve 1202 shows the input voltage rises from approximately 8.5V to approximately 11V. A curve 1204 shows the output voltage rises in proportional to the input voltage when the feedforward controlled charge pump operates in a first duty cycle. At a point 1206, when the input voltage is more than a predetermined threshold (e.g., 9.5V), the modulator 214 (shown in FIG. 2) generates a second duty cycle, which is less than the first duty cycle. As a result, the output voltage is bended back as indicated by a curve 1208. As shown in FIG. 12, the duty cycle change helps to reduce the output voltage variation.

FIG. 13 illustrates in detail the duty modulation control mechanism shown in FIG. 12. The upper vertical axis of FIG. 13 represents the input voltage of a feedforward controlled charge pump. The middle vertical axis of FIG. 13 represents the duty cycle of the gate drive signals of the switched capacitor network 102 (shown in FIG. 3). The bottom vertical axis of FIG. 13 is the output voltage of the feedforward controlled charge pump. As shown in FIG. 13, when the input voltage illustrated by a curve 1302 is more than a threshold voltage (e.g., 9.5V as shown in FIG. 13), the duty cycle changes from about 40% (e.g., the duty cycle of pulse 1304) to about 8% (e.g., the duty cycle of pulse 1306). As a result, the output voltage drops from a voltage approximately equal to 6V. As shown in FIG. 13, a curve 1308 shows the output voltage is about 6V before the duty cycle change. In response to the duty cycle change, a slope 1310 shows the output voltage drops despite that the input voltage keeps increasing.

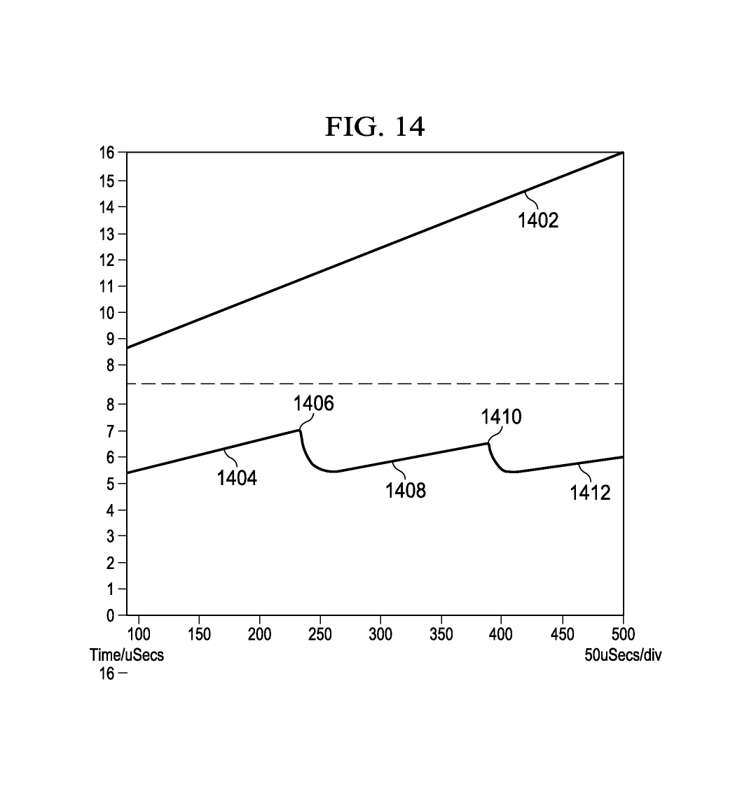

FIG. 14 shows two curves illustrating the output voltage versus the input voltage in accordance with another embodiment. The horizontal axis of FIG. 14 is a time axis. The upper vertical axis of FIG. 14 represents the input voltage of a feedforward controlled charge pump. The bottom vertical axis of FIG. 14 represents the output voltage of the feedforward controlled charge pump. A curve 1402 shows the input voltage rises from approximately 8.5V to approximately 16V. In accordance with an embodiment, when the input voltage is between 8.5V and 11V, the switched capacitor network 102 is configured to form a ⅔ charge pump. A curve 1404 shows the output voltage rises in proportional to the input voltage. At a point 1406, when the input voltage is more than a predetermined threshold (e.g., 11V), the mode selector reconfigures the switched capacitor network so as to form a ½ charge pump. As a result, the output voltage is bended back as indicated by a curve 1408. Likewise, when the input voltage reaches another predetermined threshold (e.g., 14V), the mode selector reconfigures the switched capacitor network again to form a ⅖ charge pump. As such, by selecting a lower multiplication factor in response to the increase of the input voltage, the output voltage remains within a relatively tight range (e.g., from 5.5V to 7V).

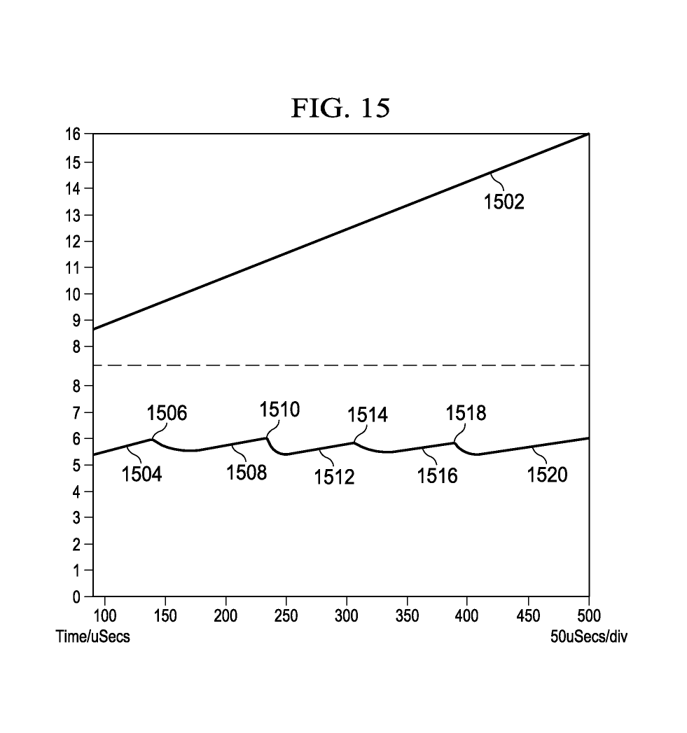

FIG. 15 shows two curves illustrating the output voltage versus the input voltage in accordance with yet another embodiment. The output voltage waveform of FIG. 15 is similar to that of FIG. 14 except that the charge pump may employ a hybrid control mechanism. In other words, the duty cycle control shown in FIG. 12 and the mode selection control shown in FIG. 14 are employed in an alternating manner in FIG. 15. At points 1506 and 1514, the duty cycle control is employed to reduce the output voltage when the input voltage reaches the predetermined thresholds. Similarly, at points 1510 and 1518, the mode selection control may be employed to reduce the output voltage by configuring the switched capacitor network to form a charge pump with a lower multiplication factor. As shown in FIG. 15, by employing a combination of the duty cycle control and the mode selection control, the output voltage remains a tighter range (e.g., from 5.5V to 6V).

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An apparatus comprising:
a switched capacitor network coupled between an input voltage source and an output capacitor, wherein the switched capacitor network comprises a plurality of flying capacitors and a switching circuit; and
a feedforward controller comprising:
a sensor configured to detect an input voltage of the input voltage source; and
a mode selector, a duty cycle modulator and a frequency modulator configured to generate a plurality of gate drive signals for the switched capacitor network based upon the input voltage, wherein the plurality of gate drive signals configure the switched capacitor network to form a first charge pump with a first non-integer multiplication factor, and wherein the first non-integer multiplication factor keeps an output voltage of the switched capacitor network within a predetermined range.

2. The apparatus of claim 1, wherein the mode selector configures the switched capacitor network to form a second charge pump with a second non-integer multiplication factor when the input voltage is more than a threshold voltage.

3. The apparatus of claim 1, wherein the mode selector configures the switched capacitor network to form the first charge pump with the first non-integer multiplication factor when the input voltage is less than a threshold voltage.

4. The apparatus of claim 1, wherein:
the duty cycle modulator configured to generate a first duty cycle for the switched capacitor network when the input voltage is more than a threshold voltage.

5. The apparatus of claim 1, wherein:
the duty cycle modulator configured to generate a second duty cycle for the switched capacitor network when the input voltage is less than a threshold voltage.

6. The apparatus of claim 1, wherein:
the frequency modulator configured to generate a first switching frequency for the switched capacitor network when the input voltage is more than a threshold voltage.

7. The apparatus of claim 6, wherein:
the frequency modulator configured to generate a second switching frequency for the switched capacitor network when the input voltage is less than the threshold voltage.

8. The apparatus of claim 1, wherein the sensor comprises a resistor divider coupled to the input voltage.

9. The apparatus of claim 1, wherein the feedforward controller comprises:
the mode selector configured to change an operating mode of the switched capacitor network; and
the duty cycle modulator configured to adjust duty cycles of the switched capacitor network, wherein the mode selector and the duty cycle modulator are applied to the switched capacitor network in an alternating manner.

10. The apparatus of claim 1, wherein the feedforward controller comprises:
the mode selector configured to change an operating mode of the switched capacitor network; and
the frequency modulator configured to adjust a switching frequency of the switched capacitor network, wherein the mode selector and the frequency modulator are applied to the switched capacitor network in an alternating manner.

11. A charge pump comprising:
a plurality of flying capacitors coupled between an input direct current (dc) voltage source and an output capacitor;
a switching circuit coupled to the plurality of flying capacitors, wherein the switching circuit and the plurality of flying capacitors form a switched capacitor network, wherein the switching circuit has a plurality of configurations, each of which forms a charge pump with a multiplication factor; and
a feedforward controller configured to:
detect an input dc source voltage; and
configure the switching circuit to form a charge pump with a first non-integer multiplication factor based upon the input dc source voltage.

12. The charge pump of claim 11, wherein the switching circuit is configured such that:
the flying capacitor and the switching circuit form the charge pump with a lower multiplication factor when the output of the input dc voltage source is at a higher voltage level; and
the flying capacitor and the switching circuit form the charge pump with a higher multiplication factor when the output of the input dc voltage source is at a lower voltage level.

13. The charge pump of claim 11, wherein the first non-integer multiplication factor keeps an output voltage of the switched capacitor network within a predetermined range.

14. A method comprising:
detecting an input voltage; and
configuring a switched capacitor network such that:
the switched capacitor network forms a charge pump with a lower non-integer multiplication factor when the input voltage is more than a threshold.

15. The method of claim 14, further comprising:
a duty cycle modulator generating gate drive signals for the switched capacitor network, wherein a duty cycle of the gate drive signals is reduced when the input voltage is more than the threshold.

16. The method of claim 14, wherein the lower non-integer multiplication factor keeps an output voltage of the switched capacitor network within a predetermined range.

17. The method of claim 14, further comprising:
detecting the input voltage using a resistor divider coupled between the input voltage and ground.

18. The method of claim 14, further comprising:
configuring the switched capacitor network to form a charge pump with a first multiplication factor;
detecting a voltage increase at the input voltage; and
configuring the switched capacitor network to form the charge pump with a second multiplication factor, wherein the second multiplication factor is lower than the first multiplication factor.

19. The method of claim 14, further comprising:
applying a duty cycle control mechanism and a mode control mechanism to the switched capacitor network in an alternating manner.

20. The method of claim 14, further comprising:
applying a frequency modulation control mechanism and a mode control mechanism to the switched capacitor network in an alternating manner.
